(19) United States
(12) Patent Application Publication
(10) Pub. No.: US 2021/0034763 A1
(43) Pub. Date: Feb. 4, 2021

(54) Splitting Sensitive Data and Storing Split Sensitive Data in Different Application Environments

(71) Applicant: Huawei Technologies Co., Ltd., Shenzhen (CN)

(72) Inventors: Zhuofei Li, Beijing (CN); Hui Li, Helsinki (FI)

(73) Assignee: Huawei Technologies Co., Ltd., Shenzhen (CN)

(21) Appl. No.: 16/966,670

(22) PCT Filed: Jan. 31, 2018
(86) PCT No.: PCT/CN2018/074833

§ 371 Date: Jul. 31, 2020

(51) Int. Cl. G06F 21/60; G06F 21/62; H04L 9/08; G06F 16/13

(52) U.S. Cl. CPC G06F 21/602; G06F 21/629; H04L 9/0866; G06F 16/13; H04L 9/083

(57) ABSTRACT

A method for data storage in a terminal and a terminal related to the field of communications technologies, where the method is applied to the terminal, where application environments of the terminal include a rich execution environment (REE), and further include either or both of a trusted execution environment (TEE) and a secure element (SE), security of the SE is higher than that of the TEE, the security of the TEE is higher than that of the REE, and the method includes splitting, by the terminal, sensitive data into two files, and storing the split two files in storage spaces of different application environments.

### TECHNICAL FIELD

This application relates to the field of communications technologies, and in particular, to a method for data storage in a terminal and a terminal.

### BACKGROUND

As biometric recognition technologies become increasingly mature, more and more applications on a terminal may use biometric recognition technologies such as fingerprint recognition, facial recognition, and iris recognition to verify an identity of a user. After the user records data that is related to a biometric feature of the user and that is used as a template for verification, such as a fingerprint template, a face template, or an iris template, the terminal needs to store the data. These pieces of data are extremely important, and remain unchanged throughout the user's life. If the data is leaked, the data may be maliciously copied to another device for use. This may bring great loss to the user.

Currently, the terminal invokes a TEE encryption storage service through an application in a trusted execution environment (Trust Execution Environment, TEE) to encrypt the important data, and then stores the encrypted important data in storage space of a rich execution environment (Rich Execution Environment, REE). However, the data stored in the REE after being encrypted in the TEE is still not secure enough, and there is still a risk that the data is unauthorizedly obtained by another application. For example, a terminal product adopting this storage method can only reach an evaluation assurance level (Evaluation Assurance Level, EAL) 2 during level evaluation of information security products. It can be learned that storage security of some important data needs to be further improved.

### SUMMARY

This application provides a method for data storage in a terminal and a terminal, to improve data security of the terminal.

According to a first aspect, a method provided in this application is applied to a terminal, where application environments of the terminal include a rich execution environment REE, and further include either or both of a trusted execution environment TEE and a secure element SE, security of the SE is higher than that of the TEE, the security of the TEE is higher than that of the REE, and the method specifically includes: generating, by the terminal, a second file and a third file based on a first file; and respectively storing, by the terminal, the second file and the third file in different storage spaces, where the different storage spaces include storage spaces of different application environments of the terminal.

The second file is generated by the terminal based on first content in the first file, the third file is generated by the terminal based on second content in the first file, and the first content is different from the second content.

The first file may be a file including sensitive data or an important file that is determined by the terminal based on a service type of an application corresponding to the first file. The application corresponding to the first file may be an application that generates the first file, or may be an application that obtains the first file. For example, for a mobile payment application, a fingerprint template file, a face template file, an iris template file, or the like may be considered as the file including sensitive data, namely the first file. A key or the like used in a payment process may be considered as the important file, or may be the first file. The first file may be any file that is in any application and whose storage security needs to be improved. This is not limited in the embodiments of this application.

For example, the terminal may split the first file into two files: the second file and the third file. If the second file or the third file is not obtained, the first file cannot be restored based on only one of the files. In some embodiments, a file size of the second file is greater than or equal to that of the third file.

It can be learned that in this application, the terminal splits the first file into the two files: the second file and the third file, and respectively stores the second file and the third file in the different storage spaces. The second file and the third file have such a feature that no terminal can restore the first file completely or partially by obtaining either of the two files. In this way, a possibility that both the second file and the third file are leaked is reduced in this application. This improves security of storing the first file by the terminal.

In a possible design, before the generating, by the terminal, a second file and a third file based on a first file, the method further includes: encrypting, by the terminal, the first file; and splitting, by the terminal, the encrypted first file into the first content and the second content.

Encryption processing performed by the terminal on the first file may be in any one or more of a salt (salt) encryption algorithm, a hash (hash) encryption algorithm, an advanced encryption standard (Advanced Encryption Standard, AES) encryption algorithm, national specific Chinese national cryptographic algorithms (for example, an SM4 algorithm), and the like. This is not limited in the embodiments of this application.

Therefore, encryption processing performed before the first file is split facilitates improving security of storing the first file by the terminal.

In a possible design, the third file or the second file generated by the terminal includes a key used when the terminal encrypts the first file.

It should be noted that a quantity of bytes of the second file may be the same as that of the third file. In this way, storage space required for storing the second file is the same as that required for storing the third file, so that there may be no need to distinguish the storage space used for storing the second file and the storage space used for storing the third file. Alternatively, a quantity of bytes of the second file may be different from that of the third file. For example, the quantity of bytes of the second file may be greater than or equal to that of the third file, so that the second file may be stored in relatively small storage space. This facilitates flexibly storing the second file and the third file.

In this way, when obtaining the first file based on the second file and the third file, the terminal may obtain, from the responding third file or the responding second file, the key used when the terminal encrypts the first file, to decrypt the obtained encrypted first file to obtain the first file.

In a possible design, the respectively storing, by the terminal, the second file and the third file in different storage spaces of the terminal includes: storing, by the terminal, the second file in storage space of the REE, and storing the third file in storage space of the TEE; or storing, by the terminal, the second file in storage space of the REE, and storing the third file in storage space of the TEE; or storing, by the terminal, the second file in storage space of the TEE, and storing the third file in storage space of the SE, where a size of the second file is less than or equal to that of the third file.

Because the second file and the third file are stored in the storage spaces of the different application environments of the terminal, there is a relatively small possibility that another application reads both the second file and the third file. This facilitates improving security of storing the first file by the terminal.

In a possible design, the storing, by the terminal, the second file in storage space of the SE includes: invoking, by the terminal, a TEE encryption storage service to encrypt the second file, and storing the encrypted second file in the storage space of the REE.

In a possible design, the storing, by the terminal, the third file in storage space of the SE includes: encrypting, by the terminal, the third file, and storing the encrypted third file in the storage space of the SE by using an application protocol data unit APDU command.

In a possible design, the method further includes: obtaining, by the terminal, the first file based on the second file and the third file.

Specifically, when the terminal needs to read the first file, the terminal separately reads the second file and the third file from the different storage spaces, and then synthesizes the second file and the third file into the first file by using an inverse operation of a split method.

According to a second aspect, this application provides a terminal. Application environments of the terminal include a rich execution environment REE, and further include either or both of a trusted execution environment TEE and a secure element SE, where security of the SE is higher than that of the TEE, and the security of the TEE is higher than that of the REE. The terminal includes: a generation unit, configured to generate a second file and a third file based on a first file, where the second file is generated by the terminal based on first content in the first file, the third file is generated by the terminal based on second content in the first file, and the first content is different from the second content; and a processing unit, configured to respectively store the second file and the third file generated by the generation unit in different storage spaces of a storage unit, where the different storage spaces include storage spaces of different application environments of the terminal.

In a possible design, the first file is sensitive data in an application program of the terminal.

In a possible design, the sensitive data in the application program of the terminal includes any one of a fingerprint template file, a face template file, and an iris template file.

In a possible design, the terminal further includes a first encryption unit, configured to encrypt the first file, and the processing unit is configured to split the first file encrypted by the first encryption unit into the first content and the second content.

In a possible design, the third file includes a key used when the terminal encrypts the first file.

In a possible design, the processing unit is configured to: store the second file in storage space of the REE of the storage unit, and store the third file in storage space of the SE of the storage unit; or store the second file in storage space of the REE of the storage unit, and store the third file in storage space of the TEE of the storage unit; or store the second file in storage space of the TEE of the storage unit, and store the third file in storage space of the SE of the storage unit; and a size of the second file is greater than or equal to that of the third file.

In a possible design, the processing unit is further configured to: invoke a TEE encryption storage service to encrypt the second file, and store the encrypted second file in the storage space of the REE of the storage unit.

In a possible design, the second encryption unit is configured to: encrypt the third file, and store the encrypted third file in the storage space of the SE of the storage unit by using an application protocol data unit APDU command.

In a possible design, the generation unit is further configured to obtain the first file based on the second file and the third file.

According to a third aspect, a terminal is provided, including a processor, a memory, and a touchscreen, where the memory and the touchscreen are coupled to the processor, the memory is configured to store computer program code, the computer program code includes a computer instruction, and when the processor reads the computer instruction from the memory, the method for data storage according to any possible design method in the first aspect is performed.

According to a fourth aspect, a computer storage medium is provided, including a computer instruction, where when the computer instruction runs on a terminal, the terminal is enabled to perform the method for data storage according to any possible design method in the first aspect.

According to a fifth aspect, a computer program product is provided. When the computer program product runs on a computer, the computer is enabled to perform the method for data storage according to any possible design method in the first aspect.

### BRIEF DESCRIPTION OF DRAWINGS

FIG. 1 is a schematic structural diagram 1 of a terminal according to this application;

FIG. 2 is a schematic diagram of a method for data storage in a terminal in the prior art;

FIG. 3 is a schematic structural diagram 2 of a terminal according to this application:

FIG. 4 is a schematic flowchart of a method for storing a first file by a terminal according to this application;

FIG. 5 is a schematic diagram of a method for splitting a first file by a terminal according to this application;

FIG. 6 is a schematic diagram of a method for synthesizing a first file by a terminal according to this application;

FIG. 7 is a schematic diagram 1 of a method for storing a first file by a terminal according to this application;

FIG. 8 is a schematic diagram of a format of an application protocol data unit APDU command according to this application;

FIG. 9 is a schematic diagram 2 of a method for storing a first file by a terminal according to this application;

FIG. 10 is a schematic structural diagram 3 of a terminal according to this application; and

FIG. 11 is a schematic structural diagram 4 of a terminal according to this application.

### DESCRIPTION OF EMBODIMENTS

To describe the technical solutions provided in this application more clearly, several application environments of a terminal in the embodiments of this application are first briefly described.

FIG. 1 is a schematic diagram of a terminal including a plurality of application environments according to an embodiment of this application. The terminal includes three application environments: an REE, a TEE, and a secure element (Secure Element, SE).

The REE includes a general operating system running on a general-purpose embedded processor, for example, a rich OS (Rich Operating System) or a kernel, and a client application (client application, CA) on the operating system. Although many security measures such as device access control, a device data encryption mechanism, an isolation mechanism during application running, and permission-based access control are used in the REE, security of sensitive data cannot be ensured.

The TEE is a running environment independent of the general operating system. The TEE provides a security service for the general operating system and is isolated from the general operating system. The general operating system and an application program in the general operating system cannot directly access hardware and software resources in the TEE. The TEE provides a trusted running environment for a trusted application (trusted software authorized by the TEE), namely a TA (TEE application), and ensures end-to-end security by protecting confidentiality and integrity and by controlling data access permission. The trusted execution environment is parallel to the general operating system of the terminal, and interacts with the general operating system through a secure application programming interface (Application Programming Interface. API).

The TEE provides a running environment with a security level higher than that of the general operating system, but cannot provide a secure key storage and key running environment at a hardware isolation level. This is because a cryptographic unit in the TEE is still invoked by the REE through the API. A cryptographic module compiled in the TEE still works in an invoked slave (slave) mode, and security is relatively low.

The SE is used to construct a trusted and secure key storage and key calculation environment. A software system in the SE is simple, and there are relatively few hardware components. Therefore, it is easy to establish physical protection and implement security assurance to improve security strength of the SE, so that the SE may serve a security system requiring higher security. An application in the SE is referred to as an applet, and an operating system in the SE is referred to as a COS (Chip Operating System).

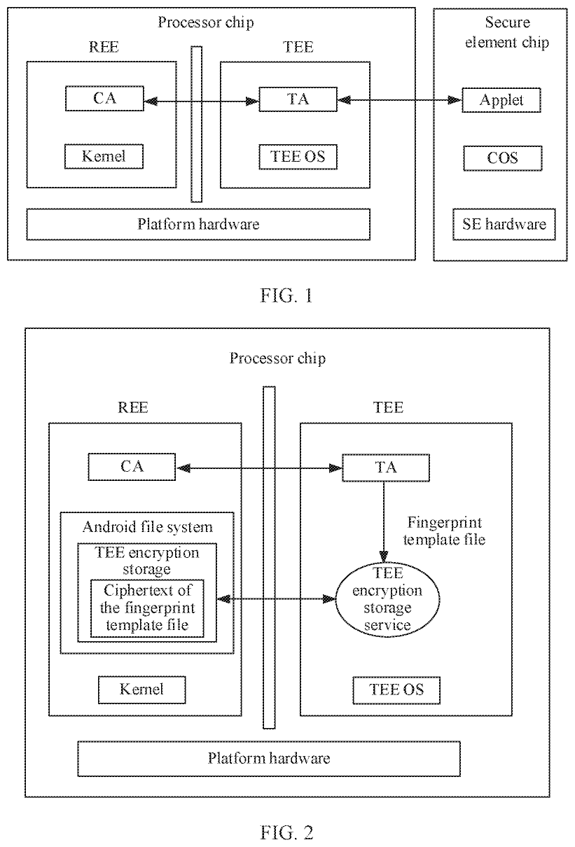

As shown in FIG. 2, the following uses an example in which the terminal stores a fingerprint template of a user to separately and briefly describe processes of storing and reading an important file by the terminal.

Specifically, when the user records a fingerprint, the TA obtains a fingerprint template file. The TA invokes a TEE encryption storage service to encrypt the fingerprint template file and store a ciphertext of the fingerprint template file in storage space of the REE. When the user enters a fingerprint, and the terminal needs to invoke the fingerprint template file to compare the fingerprint template file with the fingerprint, the TA invokes the TEE encryption storage service, reads the ciphertext of the fingerprint template file from the storage space of the REE, decrypts the ciphertext to obtain a plaintext of the fingerprint template file, and compares the plaintext of the fingerprint template file with the new fingerprint.

It should be noted that, such a TEE storage manner is higher than an REE storage manner in terms of security, but still cannot meet a requirement of such an application for storage security of data related to a biometric feature of the user. To improve storage security of important data, the embodiments of this application provide a method for data storage. The important data may be split into at least two parts, and the two parts of data are respectively stored in storage areas in different application environments.

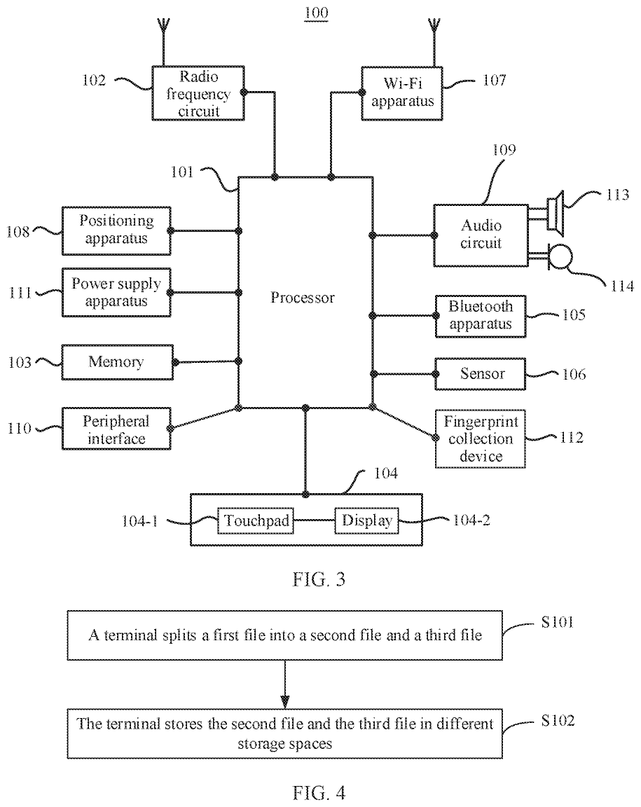

For example, the terminal in this application may be a mobile phone (for example, a mobile phone 100 shown in FIG. 3), a tablet computer, a personal computer (Personal Computer, PC), a personal digital assistant (personal digital assistant, PDA), a smartwatch, a netbook, a wearable electronic device, an augmented reality (Augmented Reality, AR) technology device, a virtual reality (Virtual Reality, VR) device, or the like that can install an application program and display an application program icon. A specific form of the terminal is not specially limited in this application.

As shown in FIG. 3, the mobile phone 100 is used as an example of the foregoing terminal. The mobile phone 100 may specifically include: components such as a processor 101, a radio frequency (Radio Frequency, RF) circuit 102, a memory 103, a touchscreen 104, a Bluetooth apparatus 105, one or more sensors 106, and a wireless fidelity (Wireless Fidelity, WI-FI) apparatus 107, a positioning apparatus 108, an audio circuit 109, a peripheral interface 110, and a power supply apparatus 111. These components may communicate with each other through one or more communications buses or signal cables (not shown in FIG. 3). A person skilled in the art may understand that a hardware structure shown in FIG. 3 does not constitute a limitation on the mobile phone, and the mobile phone 100 may include more or fewer components than those shown in the figure, may combine some components, or may have different component arrangements.

The following describes the components of the mobile phone 100 in detail with reference to FIG. 3.

The processor 101 is a control center of the mobile phone 100. The processor 101 is connected to parts of the mobile phone 100 through various interfaces and cables, runs or executes an application program stored in the memory 103, and invokes data stored in the memory 103, to perform various functions of the mobile phone 100 and process data. In some embodiments, the processor 101 may include one or more processing units. For example, the processor 101 may be a chip Kirin 960 manufactured by Huawei Technologies Co., Ltd.

The radio frequency circuit 102 may be configured to receive and send a radio signal in an information receiving and sending process or a call process. Particularly, after receiving downlink data from a base station, the radio frequency circuit 102 may send the downlink data to the processor 101 for processing, and sends related uplink data to the base station. Usually, the radio frequency circuit includes but is not limited to an antenna, at least one amplifier, a transceiver, a coupler, a low noise amplifier, a duplexer, and the like. In addition, the radio frequency circuit 102 may further communicate with another device through wireless communication. Any communications standard or protocol may be used for the wireless communication, including but not limited to the global system for mobile communications, general packet radio service, code division multiple access, wideband code division multiple access, long term evolution, email, SMS message service, and the like.

The memory 103 is configured to store an application program and data. The processor 101 runs the application program and the data that are stored in the memory 103, to execute various functions of the mobile phone 100 and process data. The memory 103 mainly includes a program storage area and a data storage area. The program storage area may store an operating system, and an application program required by at least one function (for example, a sound playback function or an image playing function). The data storage area may store data (for example, audio data or a phone book) created based on use of the mobile phone 100. In addition, the memory 103 may include a high-speed random access memory (Random Access Memory, RAM), or may include a nonvolatile memory such as a magnetic disk storage device, a flash storage device, or another volatile solid-state storage device. The memory 103 may store various operating systems such as an iOS® operating system developed by the Apple Inc. and an Android® operating system developed by the Google Inc. The memory 103 may be independent, and is connected to the processor 101 through the communications bus; or the memory 103 may be integrated with the processor 101.

The touchscreen 104 may specifically include a touchpad 104-1 and a display 104-2.

The touchpad 104-1 may collect a touch event (for example, an operation performed by a user of the mobile phone 100 on the touchpad 104-1 or near the touchpad 104-1 by using any proper object such as a finger or a stylus) performed by the user on or near the touchpad 104-1, and send collected touch information to another device (for example, the processor 101). The touch event performed by the user near the touchpad 104-1 may be referred to as a floating touch. The floating touch may mean that the user does not need to directly touch the touchpad for selecting, moving, or dragging an object (for example, an icon), and the user only needs to be near the device to execute a desired function. In addition, the touchpad 104-1 may be implemented in a plurality of types such as a resistive type, a capacitive type, an infrared type, and a surface acoustic wave type.

The display (also referred to as a display) 104-2 may be configured to display information entered by the user or information provided for the user, and various menus of the mobile phone 100. The display 104-2 may be configured in a form such as a liquid crystal display or an organic light-emitting diode. The touchpad 104-1 may cover the display 104-2. After detecting the touch event on or near the touchpad 104-1, the touchpad 104-1 transfers the touch event to the processor 101 to determine a type of the touch event. Then, the processor 101 may provide corresponding visual output on the display 104-2 based on the type of the touch event. Although in FIG. 3, the touchpad 104-1 and the display 104-2 are used as two independent components to implement input and output functions of the mobile phone 100, in some embodiments, the touchpad 104-1 and the display 104-2 may be integrated to implement the input and output functions of the mobile phone 100. It may be understood that the touchscreen 104 is formed by stacking a plurality of layers of materials. In the embodiments of this application, only the touchpad (layer) and the display (layer) are displayed, and another layer is not recorded in the embodiments of this application. In addition, the touchpad 104-1 may be disposed on a front side of the mobile phone 100 in a full panel form, and the display 104-2 may also be disposed on the front side of the mobile phone 100 in a full panel form. In this way, a bezel-less structure can be implemented on the front side of the mobile phone.

In addition, the mobile phone 100 may further have a fingerprint recognition function. For example, a fingerprint sensor 112 may be disposed on a rear side of the mobile phone 100 (for example, below a rear-facing camera), or a fingerprint sensor 112 may be disposed on the front side of the mobile phone 100 (for example, below the touchscreen 104). For another example, a fingerprint collection device 112 may be disposed on the touchscreen 104 to implement the fingerprint recognition function. In other words, the fingerprint collection device 112 and the touchscreen 104 may be integrated to implement the fingerprint recognition function of the mobile phone 100. In this case, the fingerprint collection device 112 is disposed on the touchscreen 104, and may be a part of the touchscreen 104, or may be disposed on the touchscreen 104 in another manner. A main component of the fingerprint collection device 112 in the embodiments of this application is a fingerprint sensor. The fingerprint sensor may use any type of sensing technology, which includes but is not limited to an optical sensing technology, a capacitive sensing technology, a piezoelectric sensing technology, an ultrasonic sensing technology, or the like.

The mobile phone 100 may further include the Bluetooth apparatus 105, configured to implement short-range data exchange between the mobile phone 100 and another device (for example, a mobile phone or a smartwatch). In this embodiment of this application, the Bluetooth apparatus may be an integrated circuit, a Bluetooth chip, or the like.

The mobile phone 100 may further include at least one type of the sensor 106, such as a light sensor a motion sensor, and another sensor. Specifically, the light sensor may include an ambient light sensor and a proximity sensor. The ambient light sensor may adjust luminance of the display of the touchscreen 104 based on intensity of ambient light. The proximity sensor may power off the display when the mobile phone 100 is moved to an ear. As one type of the motion sensor, an accelerometer sensor may detect acceleration values in various directions (usually on three axes). The accelerometer sensor may detect a value and a direction of gravity when the accelerometer sensor is stationary, and may be applied to an application for recognizing a mobile phone posture (such as switching between landscape mode and portrait mode, a related game, and magnetometer posture calibration), a function related to vibration recognition (such as a pedometer and a knock), and the like. Other sensors such as a gyroscope, a barometer, a hygrometer, a thermometer, and an infrared sensor may be further configured on the mobile phone 100. Details are not described herein.

The Wi-Fi apparatus 107 is configured to provide, for the mobile phone 100, network access that complies with a Wi-Fi-related standard protocol. The mobile phone 100 may access a Wi-Fi access point through the Wi-Fi apparatus 107, to help the user to receive and send an email, browse a web page, access streaming media, and the like. The Wi-Fi apparatus 107 provides wireless broadband internet access for the user. In some other embodiments, the Wi-Fi apparatus 107 may also be used as a Wi-Fi wireless access point, and may provide Wi-Fi network access for another device.

The positioning apparatus 108 is configured to provide a geographic location for the mobile phone 100. It may be understood that the positioning apparatus 108 may be specifically a receiver of a positioning system such as a global positioning system (Global Positioning System, GPS), a BeiDou navigation satellite system, or a Russian GLONASS. After receiving the geographic location sent by the positioning system, the positioning apparatus 108 sends the information to the processor 101 for processing, or sends the information to the memory 103 for storage. In some other embodiments, the positioning apparatus 108 may be further a receiver of an assisted global positioning system (Assisted Global Positioning System, AGPS). The AGPS system assists the positioning apparatus 108 as an assisted server, to implement ranging and positioning services. In this case, the assisted positioning server communicates with a device such as the positioning apparatus 108 (namely, the GPS receiver) of the mobile phone 100 through a wireless communications network, to provide positioning assistance. In some other embodiments, the positioning apparatus 108 may be a positioning technology based on a Wi-Fi access point. Each Wi-Fi access point has a globally unique (Media Access Control, MAC) address, and the device can scan and collect a broadcast signal of a nearby Wi-Fi access point when Wi-Fi is enabled. Therefore, a MAC address broadcast by the Wi-Fi access point can be obtained. The device sends such data (for example, the MAC address) that can identify the Wi-Fi access point to a location server through the wireless communications network. The location server retrieves a geographic location of each Wi-Fi access point, calculates a geographic location of the device with reference to strength of the Wi-Fi broadcast signal, and sends the geographic location of the device to the positioning apparatus 108 of the device.

The audio circuit 109, a speaker 113, and a microphone 114 may provide an audio interface between the user and the mobile phone 100. The audio circuit 109 may convert received audio data into an electrical signal and then transmit the electrical signal to the speaker 113, and the speaker 113 converts the electrical signal into a sound signal for output. In addition, the microphone 114 converts a collected sound signal into an electrical signal. The audio circuit 109 receives the electrical signal, converts the electrical signal into audio data, and then outputs the audio data to the RF circuit 102, to send the audio data to, for example, another mobile phone, or outputs the audio data to the memory 103 for further processing.

The peripheral interface 110 is configured to provide various interfaces for an external input/output device (for example, a keyboard, a mouse, an external display, an external memory, or a subscriber identity module card). For example, the peripheral interface 110 is connected to the mouse through a universal serial bus (Universal Serial Bus, USB) interface, and is connected, by using a metal contact on a card slot of the subscriber identity module card, to the subscriber identity module (Subscriber Identification Module, SIM) card provided by a telecommunications operator. The peripheral interface 110 may be configured to couple the external input/output peripheral device to the processor 101 and the memory 103.

The mobile phone 100 may further include the power supply apparatus 111 (for example, a battery and a power supply management chip) that supplies power to the components. The battery may be logically connected to the processor 101 through the power supply management chip, so that functions such as charging, discharging, and power consumption management are implemented by using the power supply apparatus 111.

Although not shown in FIG. 3, the mobile phone 100 may further include a camera (a front-facing camera and/or a rear-facing camera), a flash, a micro projection apparatus, a near field communication (Near Field Communication, NFC) apparatus, and the like. Details are not described herein.

All methods in the following embodiments may be implemented on the mobile phone 100 having the foregoing hardware structure.

FIG. 4 is a flowchart of a method for data storage according to an embodiment of this application. The method specifically includes the following steps.

S101. A terminal splits a first file into a second file and a third file.

The first file may be a file including sensitive data or an important file that is determined by the terminal based on a service type of an application corresponding to the first file. The application corresponding to the first file may be an application that generates the first file, or may be an application that obtains the first file. For example, for a mobile payment application, a fingerprint template file, a face template file, an iris template file, or the like may be considered as the file including sensitive data, namely the first file. A key or the like used in a payment process may be considered as the important file, or may be the first file. The first file may be any file that is in any application and whose storage security needs to be improved. This is not limited in the embodiments of this application.

For example, the terminal may split the first file into two files: the second file and the third file. If the second file or the third file is not obtained, the first file cannot be restored based on only one of the files. In some embodiments, a file size of the second file is greater than or equal to that of the third file.

It should be noted that, to improve security of storing the first file, the first file may be encrypted before the first file is split into the second file and the third file. A method for encrypting the first file is not limited in this application.

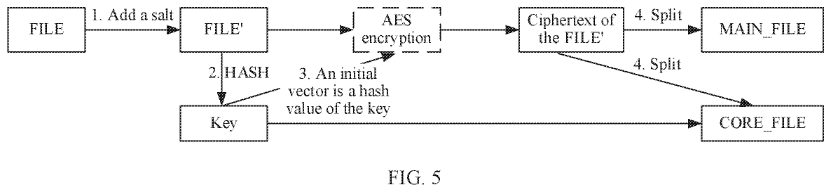

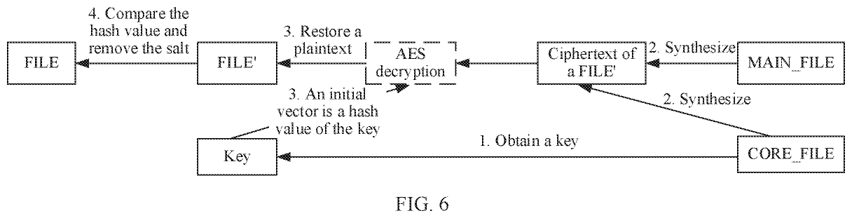

For example, FIG. 5 is a schematic diagram of a method for splitting a first file by a terminal according to an embodiment of this application. The split method specifically includes the following steps.

1. The terminal adds a salt (salt) to the first file (FILE), to obtain a fourth file (FILE′).

The salt is an encryption algorithm, and a salt adding process refers to inserting a specific character string into any specified location in the first file. The salt can be any letter, digit, or a combination of a letter and a digit, but needs to be randomly generated. In this way, even for a same file, results obtained after salts are added are different, so that a result obtained after hash (hash) is performed on the same file is inconsistent with a used hash result. This improves data security.

2. The terminal calculates a hash value of the fourth file (FILE′), to obtain a key (key) value.

The hash is used to convert an input of any length, for example, the fourth file (FILE′) herein, into an output of a specific length by using a hash algorithm. Considering that a key in an international universal advanced encryption standard (Advanced Encryption Standard, AES) encryption algorithm, national specific Chinese national cryptographic algorithms (for example, an SM4 algorithm), and the like is 32 bytes (Byte, B), the specific length herein may be, for example, 32 bytes (Byte, B). An output result is the hash value, namely the key value. The key value can be 32 B.

3. The terminal performs AES encryption on the fourth file (FILE′), to obtain a ciphertext of the fourth file (FILE′).

As a block cryptographic algorithm, the AES can work in a plurality of different encryption modes to meet different security requirements and transmission requirements. For example, in this embodiment, AES encryption may be performed on the fourth file (FILE′) in a cipher block chaining (Cipher-block chaining, CBC) mode. Specifically, the to-be-encrypted file (FILE′) is first split into several data blocks, then each to-be-encrypted data block is exclusive-ORed with a ciphertext of a previous data block, and next encryption is performed. A first data block is exclusive-ORed with a data block with an initial vector, and then is encrypted. The initial vector herein may be a hash value of the key.

4. The terminal splits the obtained ciphertext of the fourth file (FILE′) into the second file (MAIN_FILE) and the third file (CORE_FILE).

The third file (CORE_FILE) may be a combination of a part of bytes and a key value extracted from the ciphertext of the fourth file (the ciphertext of the FILE′). It is assumed that a specific quantity of bytes need to be extracted from the ciphertext of the fourth file (the ciphertext of the FILE′). In this case, one byte is extracted from each data block in the ciphertext of the fourth file (the ciphertext of the FILE′). If the total quantity of extracted bits is less than the specified quantity, extra bytes may be extracted from a last data block. For example, the specific quantity of bytes herein may be 32 B. The terminal forms the third file by combining the extracted 32 B and the key value, where a file size of the third file is 64 B.

The second file (MAIN_FILE) is a remaining part of bytes after the ciphertext of the fourth file (the ciphertext of the FILE′) is extracted.

It should be noted that a quantity of bytes of the second file may be the same as that of the third file. In this way, storage space required for storing the second file is the same as that required for storing the third file, so that there may be no need to distinguish the storage space used for storing the second file and the storage space used for storing the third file. Alternatively, a quantity of bytes of the second file may be different from that of the third file. For example, the quantity of bytes of the second file may be greater than or equal to that of the third file, so that the second file may be stored in relatively small storage space. This facilitates flexibly storing the second file and the third file.

S102. The terminal stores the second file and the third file in different storage spaces.

The different storage spaces may be different storage areas in a same application environment, or may be different storage areas in different application environments. This is not limited in the embodiments of this application.

Optionally, the terminal may invoke a TEE encryption storage service to separately encrypt the second file and the third file, and respectively store the encrypted second file and the third file in different storage spaces in an REE. Optionally, the terminal may invoke a TEE encryption storage service to encrypt one file (the second file or the third file) of the two split files, and store the encrypted file in storage space of an REE. In addition, the terminal stores the other file (the third file or the second file) of the two split files in storage space of a TEE or storage space of an SE. Optionally, the terminal may further encrypt one file (the second file or the third file) of the two split files, and store the encrypted file in storage space of a TEE, and store the other file (the third file or the second file) of the two files in storage space of an SE. Optionally, the terminal may select different storage solutions based on a service type of an application and importance of the first file. This is not limited in the embodiments of this application.

It can be learned that in this application, the terminal splits the first file into the two files: the second file and the third file, and respectively stores the second file and the third file in the different storage spaces. The second file and the third file have such a feature that no terminal can restore the first file completely or partially by obtaining either of the two files. In this way, a possibility that both the second file and the third file are leaked is reduced in this application. This improves security of storing the first file by the terminal.

Further, when the terminal needs to read the first file, the terminal separately reads the second file and the third file from the different storage spaces, and then synthesizes the second file and the third file into the first file by using an inverse operation of a split method.

For example, a process of synthesizing the second file and the third file is described herein by using the split method shown in FIG. 5 as an example. FIG. 6 is a schematic diagram of a method for synthesizing a first file by a terminal according to an embodiment of this application. A specific synthesizing process includes the following steps.

1. The terminal obtains the key value from the third file (CORE_FILE).

2. The terminal combines bytes in the third file except the key value with the second file (MAIN_FILE), to obtain the ciphertext of the fourth file (the ciphertext of the FILE′).

3. The terminal performs AES decryption on the ciphertext of the fourth file (the ciphertext of the FILE′), to obtain the fourth file (FILE′). The initial vector is the hash value of the key.

4. The terminal calculates the hash value of the obtained fourth file (FILE′), and compares the hash value with the key value. If comparison succeeds, the salt is removed from the fourth file (FILE′), to obtain the first file (FILE).

To improve storage security of the second file and the third file, this application further provides an applet established in the SE, where the applet is dedicated to storing file content of the second file or the third file. The applet may be dedicatedly used to store file content of the second file or the third file of one or more specific applications.

The following uses an example in which one TA in the TEE of the terminal is dedicated to one or more applets, to describe processes in which the TA separately stores the second file and the third file, and synthesizes the second file and the third file into the first file.

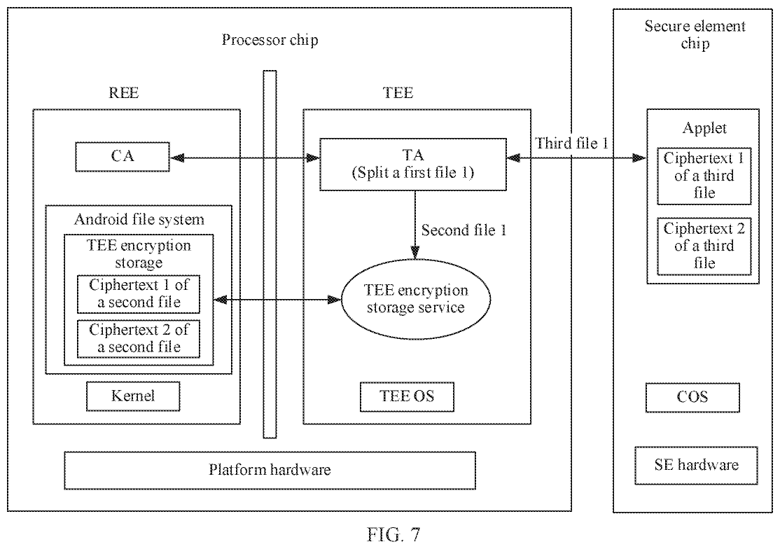

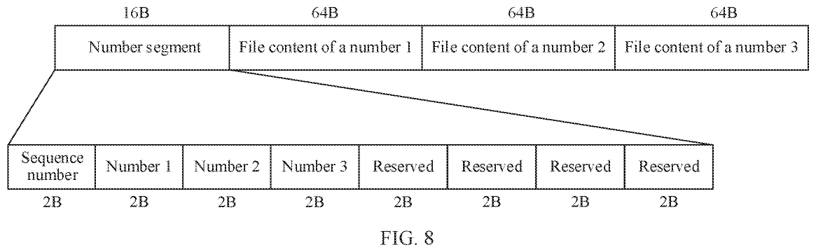

As shown in FIG. 7, the TA in the TEE of the terminal, for example, the TA may be a TA including a fingerprint (a fingerprint TA for short), splits the first file (for example, the fingerprint template file) into the second file and the third file. For a specific split method, refer to the foregoing method. Details are not described herein.

It should be noted that, considering that storage provided by the SE of the terminal may be with higher security than that of the TEE, and a storage capacity of the SE is limited, therefore, in the process in which the fingerprint TA splits the first file, a size of one of the split files may be smaller than that of the other file. It is assumed herein that a size of the third file is smaller than that of the second file. In this case, the fingerprint TA stores the second file in the TEE, and stores the third file in the applet in the SE.

Optionally, the TA defines and uses a file by using a sequence number. Therefore, before splitting the first file, the TA defines a sequence number of the first file. In this case, when the TA splits the first file into the second file and the third file, the second file and the third file have the same sequence number.

There are two storage manners in the TEE. One manner is that the TA in the TEE invokes the TEE encryption storage service, and then encrypts and stores a to-be-stored file in the REE. It should be noted that in this manner, because the TEE encryption storage service stores the key used for encryption and decryption, security is higher than that of a manner of directly storing a file in the storage space of the REE. In the other manner, the TA in the TEE stores the to-be-stored file on a dedicated chip in the TEE, for example, a replay protected memory block RPMB (Replay Protected Memory Block).

In the two storage manners in the TEE, a storage capacity of the REE is the largest. Therefore, the fingerprint TA may invoke the TEE encryption storage service, encrypt the second file, and store the encrypted second file in the REE. In this way, storage security of the second file is improved, and effective storage utilization of the terminal is improved.

Specifically, before storing the third file into the SE, the TA may encrypt the third file, and then the fingerprint TA stores the ciphertext of the third file into the applet by using an application protocol data unit (Application Protocol Data Unit, APDU) command.

It should be noted that the following APDU command is introduced for an applet dedicated to storing file information of the TA, as shown in Table 1.

TABLE 1
Example of an APDU command

| Sequence | | |
|---|---|---|
| number | APDU | Function |
| 1 | Store | Indicates that an applet stores one to three |
| | core | CORE_FILE ciphertexts |
| 2 | Get | Reads the one to three CORE_FILE ciphertexts |
| | core | from the applet |
| 3 | Delete | Indicates the applet to delete the one to four |
| | core | CORE_FILE ciphertexts |

It should be noted that, according to a main global standard GP (Global Platform) in the TEE/SE field, it can be learned that a command line including an APDU sent by the TA to the applet is as follows: CLS INS P1 P2 LEN DATA. Herein, DATA carries APDU data.

For example, FIG. 8 is an example of a data format of a store core command of an APDU. A digit of a number in a number segment is used to indicate a quantity of files carried in the command. A number 1, a number 2, and a number 3 in the number segment are separately used to carry a number of each file carried in the command. File content of each of the number 1, the number 2, and the number 3 are separately used to carry specific content of each file.

When the fingerprint TA needs to read the first file, the TA may invoke the TEE encryption service to read the second file from the REE and read the third file from the SE. Specifically, a process in which the TA reads the third file from the applet is as follows. The TA may read a ciphertext of a third file with a corresponding number by using the get core command of the APDU. It should be noted that according to a GP specification, it can be learned that data returned by the applet for the get core command of the APDU sent by the TA is as follows: RESPONSE DATA. The RESPONSE DATA carries the ciphertext of the third file returned by the applet, and the TA decrypts the ciphertext to obtain the third file.

It should be noted that the TA may also use the delete core command of the APDU to indicate the applet to delete the ciphertext of the third file with the corresponding number. The delete core command of the APDU carries a sequence number of the third file that needs to be deleted.

For a process in which the TA invokes the TEE encryption service and reads the second file from the REE, refer to the prior art. Details are not described herein.

It should be noted that if the first file is a file that needs to be compared by the TA, for example, the fingerprint template file, the face template file, or the iris template file, the TA may also record a use frequency of each third file, and during comparison, a third file with a relatively high use frequency is preferentially invoked. In this way, overall performance of the application is improved.

The following uses an example in which a plurality of TAs in the TEE of the terminal share one applet, to describe processes in which the TA separately stores the second file and the third file, and synthesizes the second file and the third file into the first file.

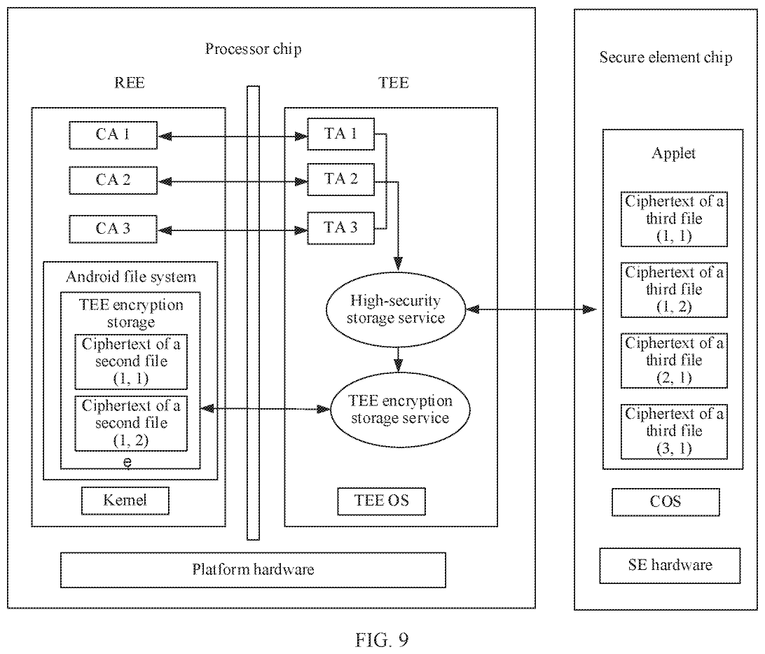

As shown in FIG. 9, a plurality of TAs sharing one applet, for example, a TA 1, a TA 2, and a TA 3, may invoke a common high-security storage service when splitting a first file to split a first file of each TA, to obtain a second file and a third file of each first file.

It should be noted that, when splitting each first file, the high-security storage service also generates a corresponding sequence number for each invoked TA. For example, a sequence number of the fingerprint TA is 1, and a sequence number of an iris-based TA application (iris TA for short) is 2. The sequence number of the invoked TA and a sequence number of a first file of the invoked TA are combined to form a two-dimensional array. The two-dimensional array is used to indicate the first file of the invoked TA. In other words, a first-dimensional number in the array may be used to identify that the third file corresponds to different applications, and a second-dimensional number may be used to identify that the third file corresponds to different first files in the applications to which the third file belongs. According to the GP specification, a command line of the APDU sent by the TA to the applet is as follows: CLS INS P1 P2 LEN DATA. Herein, DATA carries the APDU command, P1 or P2 in the command line may be used to carry a first-dimensional sequence number of the third file, that is, a sequence number of the application, and a number segment in DATA carries a second-dimensional sequence number of each file carried in the command, namely, the sequence number of the file.

For a specific method for storing and reading the second file and the third file of each TA by the high-security storage service, refer to the foregoing method. Details are not described.

Therefore, that the plurality of TAs share one applet to store critical data of each TA facilitates reducing development costs of the TA application, and improves security of storing critical data.

It can be understood that, to implement the foregoing functions, the terminal and the like include corresponding hardware structures and/or software modules for performing the functions. A person of ordinary skill in the art should easily be aware that, in combination with the examples described in the embodiments disclosed in this specification, units, algorithms, and steps may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of the embodiments of the present invention.

In the embodiments of this application, the terminal and the like may be divided into functional modules based on the foregoing method examples. For example, functional modules corresponding to various functions are obtained through division, or two or more functions may be integrated into one processing module. The integrated module may be implemented in a form of hardware, or may be implemented in a form of a software functional module. It should be noted that, in this embodiment of the present invention, module division is an example, and is merely a logical function division. In actual implementation, another division manner may be used.

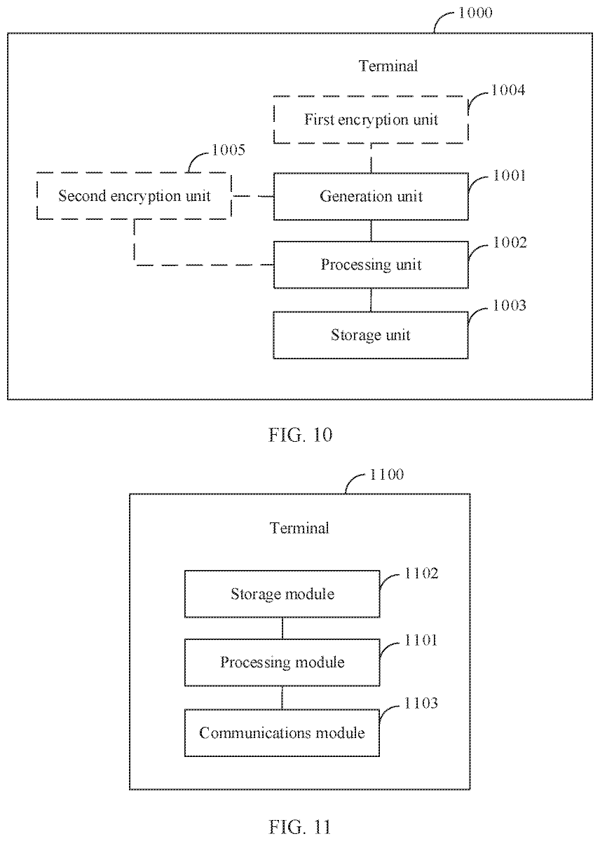

When the functional modules corresponding to various functions are obtained through division, FIG. 10 is a schematic diagram of a possible structure of the terminal in the foregoing embodiments. As shown in FIG. 10, the terminal 1000 includes a generation unit 1001, a processing unit 1002, and a storage unit 1003.

The generation unit 1001 is configured to support the terminal in generating a second file and a third file based on a first file, generating the second file based on first content in the first file, generating the third file based on second content in the first file, and generating the first file based on the second file and the third file, and/or in executing another process of the technology described in this specification. The processing unit 1002 is configured to support the terminal in storing the second file and the third file in different storage spaces of the storage unit 1003 of the terminal, and/or in executing another process of the technology described in this specification.

Further, the terminal 1000 may further include a first encryption unit 1004 and a second encryption unit 1005. The first encryption unit 1004 is configured to support the terminal in encrypting the first file, and/or in executing another process of the technology described in this specification. The second encryption unit 1005 is configured to support the terminal in encrypting the third file, and/or in executing another process of the technology described in this specification.

All related content of the steps in the foregoing method embodiments may be cited in function descriptions of the corresponding functional modules. Details are not described herein.

Certainly, the terminal 1000 may further include a communications unit, configured to perform interaction between the terminal and another device. In addition, functions that can be specifically implemented by the functional units include but are not limited to functions corresponding to the method steps in the foregoing embodiments. For detailed description of other units of the terminal 1000, refer to the detailed descriptions of the method steps corresponding to the units. Details are not described herein.

When an integrated unit is used, the generation unit 1001, the processing unit 1002, the first encryption unit 1004, and the second encryption unit 1005 may be integrated together, and may be a processing module of the terminal. The communications unit may be a communications module of the terminal, for example, an RF circuit, a Wi-Fi module, or a Bluetooth module. The storage unit 1003 may be a storage module of the terminal.

FIG. 11 is a schematic diagram of a possible structure of the terminal in the foregoing embodiments. The terminal 1100 includes a processing module 1101, a storage module 1102, and a communications module 1103. The processing module 1101 is configured to perform control and management on an action of the terminal. The storage module 1102 is configured to store program code and data of the terminal. The communications module 1103 is configured to communicate with another terminal. The processing module 1101 may be a processor or a controller, such as a central processing unit (Central Processing Unit, CPU), a general-purpose processor, a digital signal processor (Digital Signal Processor. DSP), an application-specific integrated circuit (Application-Specific Integrated Circuit, ASIC), a field programmable gate array (Field-Programmable Gate Array, FPGA), or another programmable logic device, a transistor logic device, a hardware component, or any combination thereof. The controller/processor may implement or execute various example logical blocks, modules, and circuits described with reference to content disclosed in the present invention. The processor may be a combination of processors implementing a computing function, for example, a combination of one or more microprocessors, or a combination of the DSP and a microprocessor. The communications module 1303 may be a transceiver, a transceiver circuit, a communications interface, or the like. The storage module 1102 may be a memory.

When the processing module 1101 is a processor (the processor 101 shown in FIG. 3), the communications module 1103 is an RF transceiver circuit (the radio frequency circuit 102 shown in FIG. 3), and the storage module 1102 is a memory (the memory 103 shown in FIG. 3), the terminal provided in this embodiment of this application may be the terminal 100 shown in FIG. 3. The communications module 1103 may include not only the RF circuit, but also a Wi-Fi module and a Bluetooth module. The communications module such as the RF circuit, the Wi-Fi module, and the Bluetooth module may be collectively referred to as a communications interface. The processor, the communications interface, and the memory may be coupled together through a bus.

The foregoing descriptions about implementations allow a person skilled in the art to understand that, for the purpose of convenient and brief description, division of the foregoing function modules is taken as an example for illustration. In actual application, the foregoing functions can be allocated to different modules and implemented according to a requirement, that is, an inner structure of an apparatus is divided into different function modules to implement all or some of the functions described above. For a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments of this application. The foregoing storage medium includes: any medium that can store program code, such as a flash memory, a removable hard disk, a read-only memory, a random access memory, a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A method for data storage in a terminal that is implemented by the terminal, wherein the method comprises:
generating a second file and a third file based on a first file, wherein the second file is based on first content in the first file, wherein the third file is based on second content in the first file, and wherein the first content is different than the second content; and
storing the second file and the third file in different storage spaces of different application environments of first application environments of the terminal,
wherein the first application environments comprise a rich execution environment (REE) and either or both of a trusted execution environment (TEE) and a secure element (SE),
wherein a security of the SE is higher than a security of the TEE, and
wherein the security of the TEE is higher than a security of the REE.

2. The method of claim 1, wherein the first file comprises sensitive data in an application program of the terminal.

3. The method of claim 2, wherein the sensitive data comprises a fingerprint template file.

4. The method of claim 1, wherein before generating the second file and the third file, the method further comprises:
encrypting the first file to obtain an encrypted first file; and
splitting the encrypted first file into the first content and the second content.

5. The method of claim 4, wherein the third file comprises a key for encrypting the first file.

6. The method of claim 1, further comprising:
storing the second file in a storage space of the REE; and
storing the third file in a storage space of the SE,
wherein a size of the second file is greater than or equal to a size of the third file.

7. The method of claim 6, further comprising:
invoking a TEE encryption storage service to encrypt the second file to obtain an encrypted second file; and
storing the encrypted second file in the storage space of the REE.

8. The method of claim 7, further comprising:
encrypting the third file to obtain an encrypted third file; and
storing the encrypted third file in the storage space of the SE using an application protocol data unit (APDU) command.

9. The method of claim 1, further comprising obtaining the first file based on the second file and the third file.

10.-18. (canceled)

19. A terminal, comprising:
first application environments comprising a rich execution environment (REE) and either or both of a trusted execution environment (TEE) and a secure element (SE), wherein a security of the SE is higher than a security of the TEE, and wherein the security of the TEE is higher than a security of the REE;
a memory configured to store instructions; and
a processor coupled to the memory, wherein the instructions cause the processor to be configured to:
generate a second file and a third file based on a first file, wherein the second file is based on first content in the first file, wherein the third file is based on second content in the first file, and wherein the first content is different from the second content; and
store the second file and the third file in different storage spaces of different application environments of the first application environments.

20. A computer program product comprising computer-executable instructions for storage on a non-transitory computer-readable storage medium that, when executed by a processor, cause a terminal to:
generate a second file and a third file based on a first file, wherein the second file is based on first content in the first file, wherein the third file is based on second content in the first file, and wherein the first content is different from the second content; and
store the second file and the third file in different storage spaces of different application environments of first application environments of the terminal, wherein the first application environments of the terminal comprise a rich execution environment (REE) and either or both of a trusted execution environment (TEE) and a secure element (SE), wherein a security of the SE is higher than a security of the TEE, and wherein the security of the TEE is higher than a security of the REE.

21. (canceled)

22. The method of claim 2, wherein the sensitive data comprises a face template file.

23. The method of claim 2, wherein the sensitive data comprises an iris template file.

24. The method of claim 1, further comprising:
storing the second file in a storage space of the REE; and
storing the third file in a storage space of the TEE,
wherein a size of the second file is greater than or equal to a size of the third file.

25. The method of claim 24, further comprising:
invoking a TEE encryption storage service to encrypt the second file to obtain an encrypted second file; and
storing the encrypted second file in the storage space of the REE.

26. The method of claim 1, further comprising:
storing the second file in a storage space of the TEE; and
storing the third file in a storage space of the SE,
wherein a size of the second file is greater than or equal to a size of the third file.

27. The method of claim 26, further comprising:
encrypting the third file to obtain an encrypted third file; and
storing the encrypted third file in the storage space of the SE using an application protocol data unit (APDU) command.

28. The terminal of claim 19, wherein the first file comprises sensitive data in an application program of the terminal.

29. The terminal of claim 28, wherein the sensitive data comprises a fingerprint template file, a face template file, or an iris template file.

30. The terminal of claim 19, wherein the instructions further cause the processor to be configured to:
encrypt the first file to obtain an encrypted first file; and
split the encrypted first file into the first content and the second content.
